(19) United States
(12) Patent Application Publication
(10) Pub. No.: US 2009/0058610 A1
(43) Pub. Date: Mar. 5, 2009

(54) Valve unit with electronic means of valve detection

(76) Inventors: Herbert Krebs, Garbsen (DE); Frank Jacobs, Hannover (DE)

Correspondence Address: Jack Schwartz & Associates, PLLC, Suite 1510, 1350 Broadway, New York, NY, 10018, US

(21) Appl. No.: 12/229,023

(22) Filed: Aug. 19, 2008

(30) Foreign Application Priority Data
Aug. 30, 2007 (DE) 102007041262.4

(51) Int. Cl. H04Q 5/22

(52) U.S. Cl. 340/10.1

(57) ABSTRACT

Valve unit with a plurality of valves linked together for switching a pressurized air flow, where electronic means of valve detection consisting of individual valve-side transponders and a reading device are provided, where the reading device consists of individual RFID read heads, each allocated to a transponder, as well as an RFID reading unit common to all RFID read heads, and where the RFID read heads are connected with the RFID reading unit via a multiplexer unit.

### FIELD OF THE INVENTION

The present invention concerns a valve unit with a plurality of valves linked together for switching a pressurized air flow, where each valve is allocated to at least one basic element for fluidic and/or electrical application and where electronic means of valve detection consisting of individual valve-side transponders and basic element-side reading devices are provided.

### BACKGROUND OF THE INVENTION

The range of application of pneumatic valve units extends primarily to pneumatic automation systems with which operating processes are conducted. In one valve unit there are a plurality of locally integrated valves which serve to control pneumatic assemblies, such as air cylinders, and can thus be centrally supplied with pressurized air and electrical control signals. Valve units can also possess valves with basic elements directly integrated into the casing, where channel sections for the supply and removal of pressurized air are co-integrated into the valve casing. However, the valves are embodied separately from the basic elements in the embodiment form of valve units that is of interest here. This enables a replacement of individual valves in case of maintenance without having to affect the common pressurized air supply. Every individual valve can be allocated to its own basic element, all of which in turn are linked together via corresponding channel sections. The present invention is moreover also utilizable on one-piece basic elements, which each serve at least to supply pressurized air to a plurality of valves.

A generic valve unit is shown in DE 10 2005 041 510 A1. Basic elements denoted as valve receptacles are provided here, each of which hold at least one valve for the supply and removal of pressurized air. At the same time, the electrical connection of the valves and the transmission of control signals to the valves also occur via the valve receptacle, whereupon the electronic means for valve detection allow an identification of the valves with respect to their technical data, such as electrical connection parameters and suchlike. This information is relayed via the valve receptacle to a central control unit, which monitors the correct valve equipment of the valve unit. Valve detection is technically realized through the fact that an electronic transponder with the aforementioned features is implemented in each valve casing, which is readable by means of an allocated valve receptacle-side reading device. The read data from the individual reading devices are made available to the central control unit for analysis in the manner described above. A disadvantage of this technical solution turns out to be its high complexity with regard to electronic components. For a unique reading device is allocated to every individual basic element-side transponder.

To that end, it is therefore the object of the present invention to further improve a valve unit with electronic means of valve detection so as to minimize the necessary complexity regarding electronic components for valve detection.

The object task is solved based on a valve unit corresponding to the preamble of claim 1 in connection with its characteristic features. The following dependent claims express further advantageous embodiments of the invention.

### SUMMARY OF THE INVENTION

The invention includes the technical lesson that the reading device necessary for valve detection consists of individual RFID read heads (RFID=“Radio Frequency Identification”), each of which are allocated to a transponder, as well as an RFID reading unit common to all RFID read heads, where the RFID read heads are connected with the sole RFID reading unit via a multiplexer unit.

The advantage of the solution according to the present invention lies especially in the fact that only one RFID reading unit per valve unit is necessary. The additional electronic complexity in the form of the multiplexer unit is justifiable because such electronic components are available as bulk commodities. A multiplexer is a selection combinational circuit in both analog electronics and digital technology with which a number of inputs can be selected in succession. The multiplexer unit converts the parallel data streams into serial streams through a cyclical sweep of all input signals. The RFID read heads employed within the context of the solution according to the present invention are preferably only antennas which can be constructed from spools in order to activate the respectively allocated transponders and also to read their data for their intended purpose. This saves having a separate reading unit under every valve slot.

For valves that are linked together and which draw their fluidic and/or electrical supply through channels internally running longitudinally from valve to valve, the object is solved by locating the transponder of the reading device in the area of a first contact surface of the valves that are linked together, while a RFID read head is located at the area of the second contact surface of the valve at the height level of the transponder. If the valves are now linked together, then each transponder of the valve allocated here comes in the immediate close vicinity of an RFID read head from the neighboring valve linked to it. A data reading from the transponder occurs via this RFID read head, which is a component of the reading device. However an additional RFID read head is to be integrated here in a frontal closing plate in order to be able to read all the transponders of the valve.

Besides the valves, the valve unit preferably features a bus box for connection to a serial data bus connection, which further contains the multiplexer unit with downstream RFID reading unit. This allows a separate casing for the electronic means of valve detection to be dispensed with and one can revert to the available serial data bus connection for connecting to the superordinate control unit. Alternatively, it is however also possible here to implement the electronic means of valve detection as a separate structural unit which, in addition to the bus box, can be a component of a valve unit.

The multiplexer unit is preferably constructed as a standardized multiple multiplexer for converting the parallel signals of the RFID read heads into a serial bus signal. The number of multiplexer unit inputs corresponds at minimum to the number of RFID read heads. It is suggested in this context and in accordance with a further measure to improve the invention that the multiplexer units be constructed modularly out of a plurality of multiplexer elements with a defined number of inputs. This measure allows a flexible matching to a desired number of valves. If, for example, multiplexer elements with four inputs each are utilized, then this enables multiplexer units with four, eight, twelve, etc. inputs to be constructed as needed.

If the RFID read head is merely embodied based on a kind of antenna, then, in accordance with a further measure to improve the invention, it is suggested to implement the connection between the inputs of the multiplexer unit and each RFID read head as a short wiring. Signal disturbances are thereby limited and a neutral wire common to all RFID read heads can be utilized within the framework of the parallel wiring, thus reducing the wiring complexity.

In order to receive a clear allocation of the data detected with the electronic means of valve detection to the respective valves, it is suggested that the transmission path of the individually allocated transponders activated via the RFID read heads be of very minimal measure. A minimal separation distance can for example occur through the integration of RFID read head and transponder in wall casing areas which come up directly adjacent to one another. Because valve casings are primarily manufactured from plastic using injection molding processes, a transponder can be easily molded onto this casing. The same also applies analogously for the basic element-side RFID read head. This prevents damage-sensitive wire connections from protruding out from the surface of the basic element.

### BRIEF DESCRIPTION OF THE DRAWINGS

Furthermore, the measures to improve the invention are stated in the dependent claims or are more closely illustrated below together with the specification of advantageous embodiments of the invention with reference to drawings. Shown are:

FIG. 1 a schematic page illustration of a pneumatic valve unit in a first embodiment and

FIG. 2 a schematic page illustration of a pneumatic valve unit in a second embodiment.

### DETAILED DESCRIPTION OF THE INVENTION

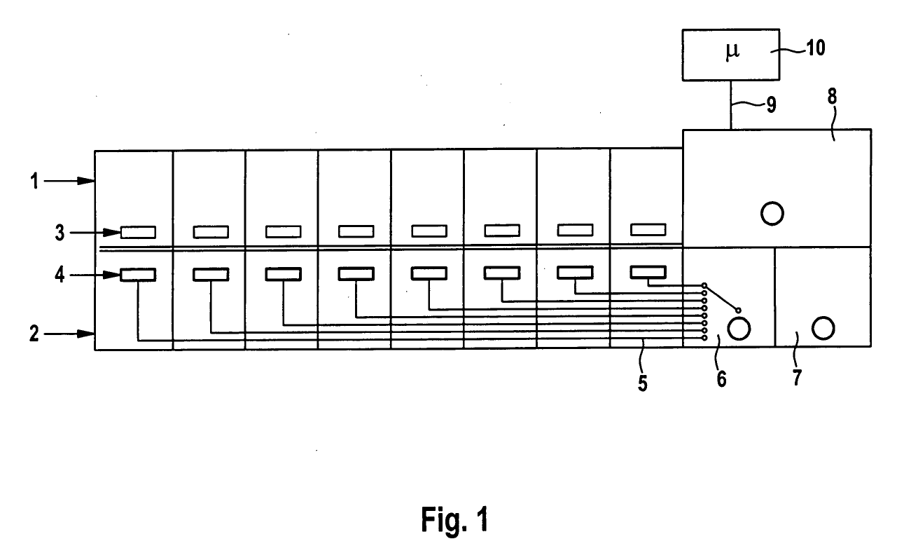

According to FIG. 1, the valve unit consists of a plurality of electro-pneumatic valves linked together (1) whose fluidic and electrical connection occurs via an individually allocated basic element (2). The individual basic elements (2) are likewise linked together and possess a (indiscernible) common channel guide for fluidic supply.

Every valve (1) contains an electronic transponder, in which the valve identification in the form of a serial number, identification for valve function, date of manufacture, as well as batch identification is stored.

A reading device, which is allocated to each transponder (3) on the basic elements (2) side, includes individual RFID read heads (4), each of which leads up to the entrance of a multiplexer unit (6) via a parallel wiring with an individual signal transmission line (5). All RFID read heads (4) can be cyclically activated with the multiplexer unit (6) in order to read the individually allocated information content of the transponders (3) and make a downstream RFID reading unit (7) available as a serial signal to said content.

The RFID reading unit (7) processes a signal and makes the data available via a bus box (8) per serial data bus connection (9) of a superordinate control unit (10).

The superordinate control unit (10) compares the current valve (1) equipment status of the valve unit with a given stored target equipment status saved in the superordinate control unit (10). If the current equipment status deviates from target status, for example regarding valve function, then the valve equipment that is false in this respect is recognized and the electronic control unit (10) prevents a restart of the pneumatic system.

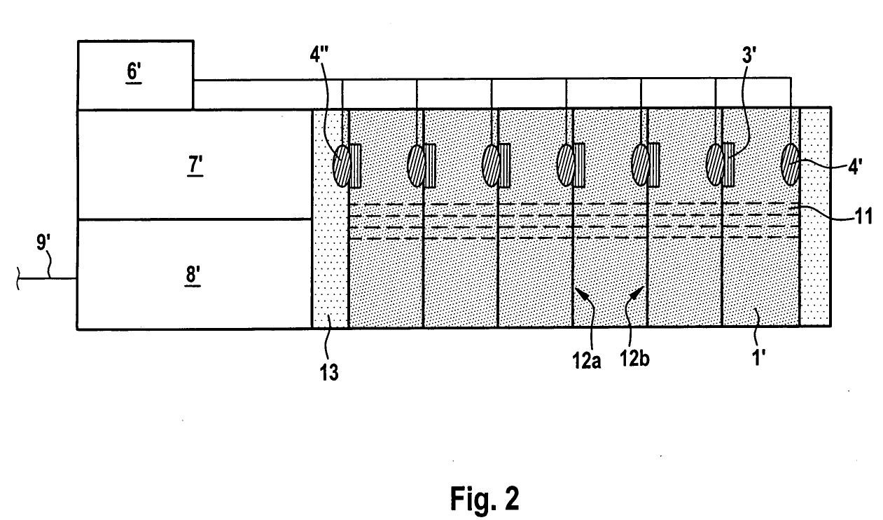

According to FIG. 2, it concerns a valve unit which forgoes a basic element for the fluidic or electrical connection. Channels (11) are located longitudinally along the valves (1′) that are linked together. These fulfill the function of the fluidic connection. Transponders (3′) are present in the area of every first contact surface (12a) of every valve (1′), while an RFID read head (4′) is positioned in the same valve (1′) on the opposing second contact surface (12b).

To guarantee a reading of all valves (1′) of the valve unit, an additional RFID read head (4″) is integrated on the side of the frontal closing plate (13), which especially serves to seal the channels (11) inside the valve.

The valve data read from the RFID read heads (4′) (exemplarily) are routed via a multiplexer unit (6′) to a RFID reading unit (7′) common to all valves (1′). The (in this respect) central RFID reading unit (7′) is a component of a bus box (8′), via which the valves (1′) primarily receive their control signals per data bus connection (9′). Data are furthermore also routed via the data bus (9′) to a—not further illustrated—central control unit for comparison of the current valve (1′) equipment status with a given target equipment status.

The invention is not limited to the above-mentioned exemplarily stated preferred embodiment. Rather there are also conceivable variations of this preferred exemplary embodiment which are also included in the extent of protection of the claims to follow. Thus it is for example also possible to locate the means of valve detection according to the present invention outside the bus box in order to optimize the internal wiring of the valve unit with respect to attaining the shortest possible signal paths.

1. Valve unit with a plurality of valves linked together for switching a pressurized air flow, where each valve is allocated at least one basic element for fluidic and/or electrical connection, and where electronic means of valve detection consisting of valve-side transponders and a basic element-side reading device are provided,
wherein the reading device consists of individual RFID heads, each allocated to a transponder and a RFID reading unit common to all RFID read heads, where the RFID read heads are connected with the RFID reading unit via a multiplexer unit.

2. Valve unit in accordance with claim 1,
wherein, in addition to the valves, a bus box is provided for linkage to a serial data bus connection, which further contains the multiplexer unit with downstream RFID reading unit.

3. Valve unit in accordance with claim 2,
wherein the bus box is connected with a superordinate control unit for comparison of the current valve equipment status with a given target equipment status.

4. Valve unit in accordance with claim 1, wherein individual basic element is allocated to every valve and the valves are fluidically and/or electrically linked with one another.

5. Valve unit with a plurality of valves linked together via corresponding contact surfaces for switching a pressurized air flow, where the valves feature common channels running longitudinally for fluidic and/or electrical connection, and where an allocated transponder is integrated into each valve such that the transponder interacts with the electronic means to enable valve detection, wherein the transponder is located in the area of the first contact surface and a RFID read head is located in the area of the second contact surface on the opposite side, where the reading device includes a RFID reading unit common to all RFID read heads, and the RFID read heads are connected with the RFID reading unit via a multiplexer unit.

6. Valve unit in accordance with claim 5,
wherein a bus box for connection to a serial data bus connection is located on a contact surface of the valves and where the bus box moreover contains the multiplexer unit with downstream RFID reading unit.

7. Valve unit in accordance with claim 6,
wherein the bus box is connected with a superordinate control unit for comparison of the current valve equipment status with a given target equipment status.

8. Valve unit in accordance with claim 5,
wherein the multiplexer unit is embodied after a kind of multiple multiplexer for converting the parallel signals of the RFID read heads into a serial bus signal and its number of inputs at minimum corresponds to the number of RFID read heads.

9. Valve unit in accordance with claim 5,
wherein the multiplexer unit is modularly constructed from a plurality of multiplexer elements with a defined number of inputs for flexible adaptation to a desired number of valves.

10. Valve unit in accordance with claim 5,
wherein the connection between the inputs of the multiplexer unit and each RFID read head is implemented as a parallel wiring running along the valves with a signal transmission line and a common neutral wire allocated to each RFID read head.

11. Valve unit in accordance with claim 5,
wherein the transmission path of the individually allocated transponders activated via the RFID read heads is so minimally measured that a well-defined allocation of the valves results.
